(19) United States
(12) Patent Application Publication
(10) Pub. No.: US 2015/0091879 A1
(43) Pub. Date: Apr. 2, 2015

(54) Finger stylus for touch screen devices

(71) Applicant: Cary Madsen, Irving, TX (US)

(72) Inventor: Cary Madsen, Irving, TX (US)

(21) Appl. No.: 14/499,480

(22) Filed: Sep. 29, 2014

Related U.S. Application Data
(60) Provisional application No. 61/885,226, filed on Oct. 1, 2013.

(51) Int. Cl. G06F 3/0354

(52) U.S. Cl. CPC G06F 3/03545
USPC 345/179

(57) ABSTRACT

A finger stylus for touch screen devices is secured to the user's index finger with a ring of flexible material such as elastic or a hook-and-loop fastener strip. This configuration allows the user to maneuver and point the cursor naturally, while still touching the screen precisely and without soiling the screen with skin oils and other material.

### CROSS-REFERENCE TO RELATED APPLICATIONS

This application claims the benefit of U.S. Provisional Application No. 61/885226, filed Oct. 1, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to accessories for personal electronic devices and in particular to a finger stylus for touch screen devices. The users of touch screen electronic devices often find that using a finger to move the cursor and select an item on the screen is far less precise than using a mouse. This often leads to selection of the wrong item, leading to delays as the user backs up to select the right item. Since touch screen devices are usually mobile devices with slower connection speeds, these delays can be substantial and very annoying. Also, touch screen use deposits skin oils, and any other material which may be on the user's fingertips, on the computer screen. A finger stylus, secured to the user's index finger with a finger ring of flexible material such as elasticized cotton or a hook-and-loop fastener strip, would resolve this problem. This configuration allows the user to maneuver and point the cursor naturally, while still touching the screen precisely and without soiling the screen with skin oils and other material.

### SUMMARY OF THE INVENTION

Accordingly, the invention is directed to a finger stylus for touch screen devices. The finger stylus is secured to the user's index finger with a finger ring of flexible material such as elasticized cotton or a hook-and-loop fastener strip. This configuration allows the user to maneuver and point the cursor naturally, while still touching the screen precisely and without soiling the screen with skin oils and other material.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 shows a bottom perspective view of the first exemplary embodiment, displaying the stylus 10, the finger ring 11, the stylus tip 12, and the tip ring 13.

FIG. 2 shows a side profile view of the first exemplary embodiment displaying the stylus 10, the finger ring 11, the stylus tip 12, the tip ring 13, and the finger ring aperture 20.

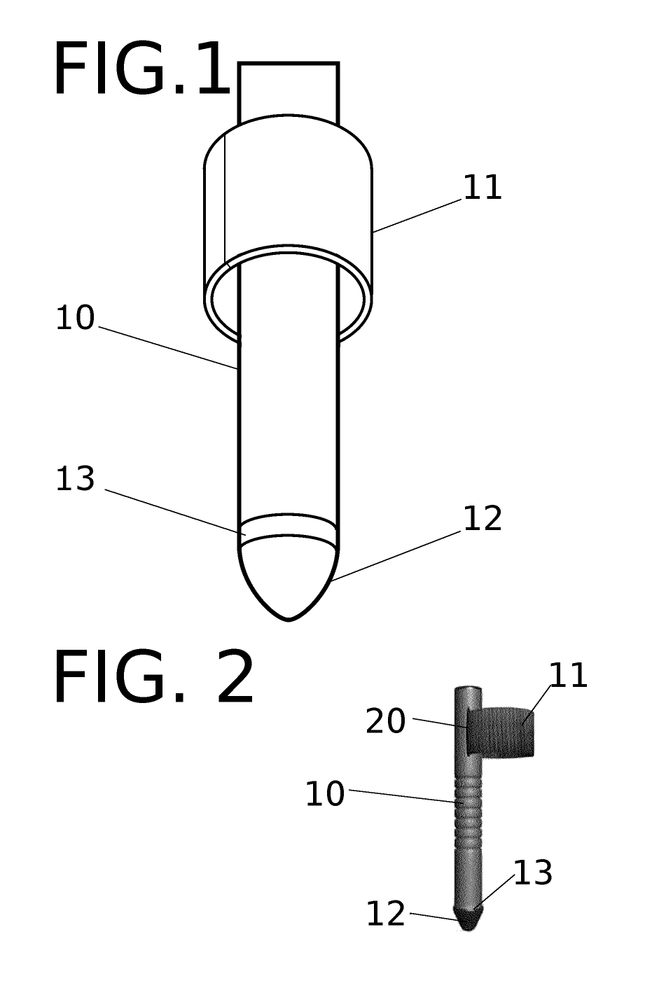

### DETAILED DESCRIPTION OF THE INVENTION

Referring now to the invention in more detail, the invention is directed to a finger stylus for touch screen devices. The finger stylus is secured to the user's index finger with a finger ring 11 of flexible material such as a loop of elasticized cotton or a fastenable and releasable loop of fabric having a pair of complementary hook-and-loop fastener strips at either end. This configuration allows the user to maneuver and point the cursor naturally, while still touching the screen precisely and without soiling the screen with skin oils and other material.

The first exemplary embodiment consists of a stylus 10, a finger ring 11, a stylus tip 12, and a tip ring 13 which is used to affix the stylus tip 12 to the lower end of the stylus 10. The finger ring 11 is manufactured from flexible materials to ensure a comfortable fit and a secure, stable platform for the stylus 10. The finger ring 12 is preferably linked to the stylus 10 by passing through an aperture 20, which pierces the stylus 10 transaxially and has a rectangular profile suitable for passing through the flat flexible material of the finger ring 12. An alternate embodiment, featuring a finger ring 11 manufactured from a more rigid material such as plastic or steel, is also contemplated; in such an embodiment, a finger ring 11 of rigid material may be monolithic with or rigidly affixed to the stylus 10 or may pass through an aperture 20 as contemplated with a finger ring 11 of soft material. The stylus tip 12 is rounded to prevent scratches on the surface of the visual display of the touch screen device.

To use the first exemplary embodiment, the user affixes the stylus tip 12 to the stylus 10 using the tip ring 13. The tip ring 13 may be formed with a threaded bore with complementary threads at the distal end of the stylus 10 and stylus tip 12. Alternatively, the stylus tip 12 may be affixed directly to the stylus 10, or the stylus lip 12 and stylus 10 may be one integral monolithic piece. The user then affixes the finger stylus to the tip of the index finger, using the finger ring 10, in such a manner that the stylus 10 is against the pad of the fingertip, and the stylus tip 12 points away from the palm of the hand. The user then taps the screen or small keys of the personal electronic device with the stylus tip 12, and maneuvers the cursor using the stylus tip 12.

The stylus 10 and tip ring 13 are preferably manufactured from rigid, durable materials such as plastic, steel, aluminum, or wood. The finger ring 11 is preferably manufactured from a flexible, durable material with an elastic quality, such as elasticized cotton or nylon. The stylus tip 12 is preferably manufactured from a rigid, durable material such as steel or plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A finger stylus for touch screen devices comprising a stylus; a stylus tip; a finger ring; said finger ring being affixed by an affixing means for affixing said finger ring to said stylus; and said stylus tip being affixed to said stylus by an affixing means for affixing said stylus tip to said stylus.

2. The finger stylus for touch screen devices of claim 1 wherein said stylus is pierced transaxially by an aperture; said aperture having a rectangular profile; and wherein said affixing means for affixing said finger ring to said stylus comprises said finger ring being passed through said aperture.

3. The finger stylus for touch screen devices of claim 1 wherein said finger ring comprises a loop of elasticized cotton.

4. The finger stylus for touch screen devices of claim 1 wherein said finger ring comprises a fastenable and releasable loop of fabric having complementary hook and loop surfaces thereon.

4. The finger stylus for touch screen devices of claim 1 wherein said finger ring is of rigid material.

6. The finger stylus for touch screen devices of claim 2 wherein said finger ring comprises a loop of elasticized cotton.

7. The finger stylus for touch screen devices of claim 2 wherein said finger ring comprises a fastenable and releasable loop of fabric having complementary hook and loop surfaces thereon.

8. The finger stylus for touch screen devices of claim 2 wherein said finger ring is of rigid material.

9. The finger stylus for touch screen devices of claim 1 wherein said affixing means for affixing said stylus tip to said stylus comprises a tip ring.

10. The finger stylus for touch screen devices of claim 1 wherein said affixing means for affixing said stylus tip to said stylus comprises said stylus tip and said stylus being one monolithic piece.

11. The finger stylus for touch screen devices of claim 2 wherein said affixing means for affixing said stylus tip to said stylus comprises a tip ring.

12. The finger stylus for touch screen devices of claim 3 wherein said affixing means for affixing said stylus tip to said stylus comprises a tip ring.

13. The finger stylus for touch screen devices of claim 4 wherein said affixing means for affixing said stylus tip to said stylus comprises a tip ring.

14. The finger stylus for touch screen devices of claim 5 wherein said affixing means for affixing said stylus tip to said stylus comprises a tip ring.

15. The finger stylus for touch screen devices of claim 6 wherein said affixing means for affixing said stylus tip to said stylus comprises a tip ring.

16. The finger stylus for touch screen devices of claim 7 wherein said affixing means for affixing said stylus tip to said stylus comprises a tip ring.

17. The finger stylus for touch screen devices of claim 8 wherein said affixing means for affixing said stylus tip to said stylus comprises a tip ring.

18. The finger stylus for touch screen devices of claim 2 wherein said affixing means for affixing said stylus tip to said stylus comprises said stylus tip and said stylus being one monolithic piece.

19. The finger stylus for touch screen devices of claim 6 wherein said affixing means for affixing said stylus tip to said stylus comprises said stylus tip and said stylus being one monolithic piece.

20. The finger stylus for touch screen devices of claim 7 wherein said affixing means for affixing said stylus tip to said stylus comprises said stylus tip and said stylus being one monolithic piece.
